(19) United States
(12) Patent Application Publication
(10) Pub. No.: US 2009/0149193 A1
(43) Pub. Date: Jun. 11, 2009

(54) Creating optimum temporal location trigger for multiple requests

(76) Inventors: Leslie Johann Lamprecht, Seattle, WA (US); Gordon John Hines, Kirkland, WA (US)

Correspondence Address: MANELLI DENISON & SELTER PLLC, 7th Floor, 2000 M Street, N.W., Washington, DC, 20036-3307, US

(21) Appl. No.: 12/292,918

(22) Filed: Dec. 1, 2008

Related U.S. Application Data
(63) Continuation of application No. 11/305,207, filed on Dec. 19, 2005.
(60) Provisional application No. 60/710,676, filed on Aug. 24, 2005.

(51) Int. Cl. H04W 4/02; H04W 4/00

(52) U.S. Cl. 455/456.1; 455/422.1

(57) ABSTRACT

A technique evaluates overlapping request intervals, and from them determines a temporal reporting interval that satisfies requirements for all that overlap. The temporal reporting interval represents a temporal trigger used to best support multiple triggers on the same target, without modification or support by the target mobile. Disclosed embodiments relate to an example of location requests wherein multiple users, by chance, request location triggered services on the same target mobile during the same time period. To minimize the usage of mobile and network resources, the present invention reduces the number of active triggers on a target mobile subjected to multiple requests (e.g., location requests from multiple tracking applications).

This application claims priority from co-pending U.S. Provisional Appl. No. 60/710,676, entitled “Method For Creating Temporal Location Triggers”, filed Aug. 24, 2005, to Lamprecht and Hines; U.S. patent application Ser. No. 10/400,639, entitled “Consequential Location Services”, filed Mar. 28, 2003, which in turn claims priority from U.S. Provisional Appl. No. 60/367,709, filed Mar. 28, 2002, to Hines, et al., the entirety of all three of which are explicitly incorporated herein by reference.

### BACKGROUND OF THE INVENTION

1. Field of the Invention

This invention relates generally to wireless telecommunication in general, including long distance carriers, Internet Service Providers (ISPs), and information content delivery services/providers. More particularly, it relates to location services for the wireless industry.

2. Background of Related Art

Location information regarding subscribers is increasingly becoming available in a wireless network. Location information relates to absolute coordinates of a wireless device.

Location services are message intensive on telecom networks. Message reduction in general is desirable, both to allow increased capacity in a wireless network, as well as to improve reliability of the system by reducing the number of messages. Moreover, system resources, such as battery life and processing power, on a mobile device are limited. In addition, network resources used in the reporting of the position of a target mobile are costly.

FIG. 4 shows a conventional LoCation Services (LCS) request.

In particular, as shown in FIG. 4, a location server 106 requests location information regarding a particular mobile subscriber (MS) from a core network node, e.g., from a Mobile Switch Center (MSC) 110. Requested information regarding a particular wireless device (MS) may include, e.g., attach, detach, and location area update. The location server 106 may also request information regarding the wireless device such as attach, detach and/or location area update from a Packet Date Node (e.g., SGSN, GGSN, or PDSN), or help the device calculate x/y direction.

Typically, location information regarding a particular wireless device is requested of a home location register (HLR).

As shown in step 1 of FIG. 4, a locations services client sends a message to a location server.

In step 2, a location server 106 sends a Provide Subscriber Info message to a Home Location Register 108, requesting subscriber information regarding a particular subscriber.

In step 3, the carrier's Home Location Register (HLR) 108 provides the subscriber information for the requested subscriber back to the location server 106.

In step 4, location information regarding the requested subscriber is requested to either an MSC or Packet Data node 110. The MSC or Packet Data Node preferably provides precise location information using, e.g., a global positioning satellite (GPS), triangulation techniques, or other relevant locating technology, or helps the device calculate X/Y direction.

In step 5, the location request is forwarded to the Radio Access Network (RAN) 112 if needed.

In step 6, precise, updated location information regarding the requested subscriber is sent to the location server (LS) 106.

In step 7, an ultimate response to the original location request is sent to the LCS client 104 that initially requested the location information.

One conventional technique for a given application to track position of a given subscriber is for the application to periodically “poll” the mobile device for its position. Conventional polling techniques utilizes a system within the wireless network that periodically requests updated location information from the desired subscriber. The polling is typically performed periodically, e.g., every N minutes. However, polling is disadvantageous in that it causes high network traffic.

Location requests where the location response (responses) is (are) required after a specific event has occurred is sometimes referred to as Deferred Location requests. The event may or may not occur immediately. This event may also be referred to as a Location Trigger.

Deferred services are useful when a client would like to know the location of a target device at certain intervals during a specific period of time. For example, a client may want to know the location of a target device every 30 minutes during the hours of 08:00 and 17:00.

Location Based Services enables multiple applications to request deferred location based services for the same target device at specific time intervals during a specific time period. The reporting interval and time period of position reporting may overlap. This leads to n number of location based period triggers active on the same target at a point in time.

FIG. 5 shows a typical location deferred service when multiple users request a deferred event on a single target mobile, in accordance with the principles of the present invention.

In particular, as shown in FIG. 5, multiple users or applications 501, 502 transmit respective location requests 521, 522 to a same mobile device 500. The location requests are routed to a location services platform 510, which in turn passes on the location requests 521a, 522a to the mobile device 500.

In response to the first location request 521a, the mobile device 500 schedules a trigger to appropriately respond with location update messages 541, 542 at a timing requested by the first user 501. Similarly, in response to the second location request 522a, the mobile device 500 also schedules an overlapping trigger to appropriately respond with position information messages 551, 552 at a timing requested by the second user 501. These position information messages 541, 542, 551, 552 are directed to the location services platform 510 so that the location services platform 510 can update a position of the mobile device 500, and are passed on as response location messages 541a, 542a, 551a, 552a to the respectively requesting users 501.

Some target devices may not support multiple active periodic triggers at the same time which implies only one application at a time can activate a period trigger. This is not practical as multiple application would require the position of the same target at similar times.

For target devices which support multiple active period triggers at the same time, it is desirable to save network and handset resources by consolidating these period triggers based on overlapping reporting intervals.

Existing systems either deny new deferred services by the location server when an existing deferred service is active, cancel the existing service and activate the new deferred service when an existing one is active on the target device, and/or allow multiple active deferred services on the same target device.

However, existing systems are disadvantageous because it is not practical to only allow a single deferred services at a time on a target device as there are multiple different users/applications which may want deferred services on the same target device. Moreover, allowing multiple active deferred services on the same target will unnecessary reduce battery life and use network resources. Some target devices can only support a single active trigger at a time. Also, if new triggers cancel existing triggers on the device because the device cannot support multiple triggers then the requesting user of the trigger may not be notified that the his/her trigger was cancelled.

With the availability of location services multiple clients may want deferred services active on the same target device during the same period of time.

There is a need to reduce the traffic requirements incumbent upon a mobile device subjected to location requests from multiple users or applications, particularly for the purpose of tracking the mobile device over a given period of time.

### SUMMARY OF THE INVENTION

In accordance with the principles of the present invention, a method and apparatus for creating an optimum temporal response trigger on a wireless device comprises receiving a plurality of overlapping trigger requests. An optimum response level is determined for at least one common parameter of each of the plurality of overlapping trigger requests. A single response is triggered to each of the plurality of overlapping trigger requests based on the optimum response level.

### BRIEF DESCRIPTION OF THE DRAWINGS

Features and advantages of the present invention will become apparent to those skilled in the art from the following description with reference to the drawings:

FIG. 1 shows an exemplary message flow including relevant messages using an optimal temporal trigger, in accordance with the principles of the present invention.

FIG. 2 shows a table representing active trigger A with its trigger characteristics at the time when trigger B is requested, in accordance with the principles of the present invention.

FIG. 3 shows a table representing the exemplary active triggers on a mobile device over time as dictated by the requirements shown in the table of FIG. 2 of Triggers A and B, resulting in an optimal temporal trigger comprising components T1 and T2, in accordance with the principles of the present invention.

FIG. 4 shows a conventional LoCation Services (LCS) request.

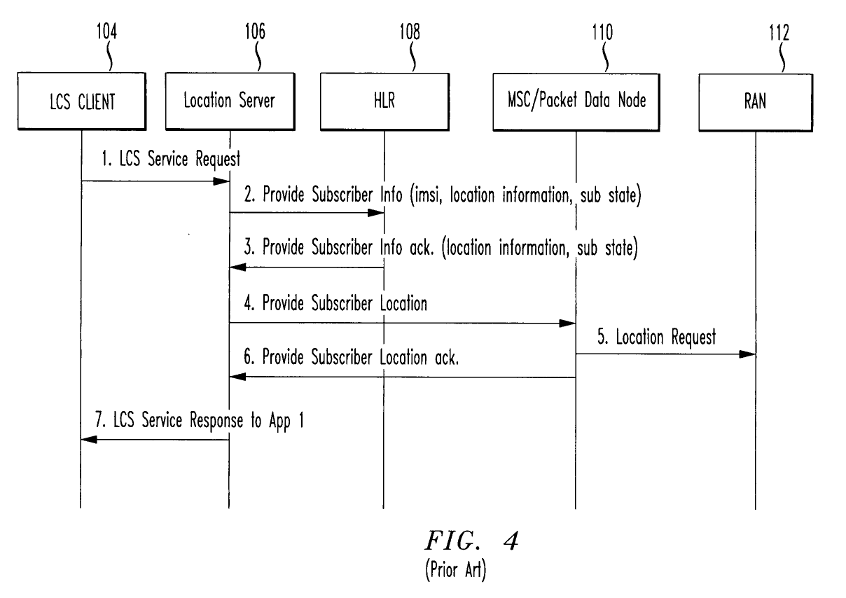

FIG. 5 shows a typical location deferred service when multiple users request a deferred event on a single target mobile, in accordance with the principles of the present invention.

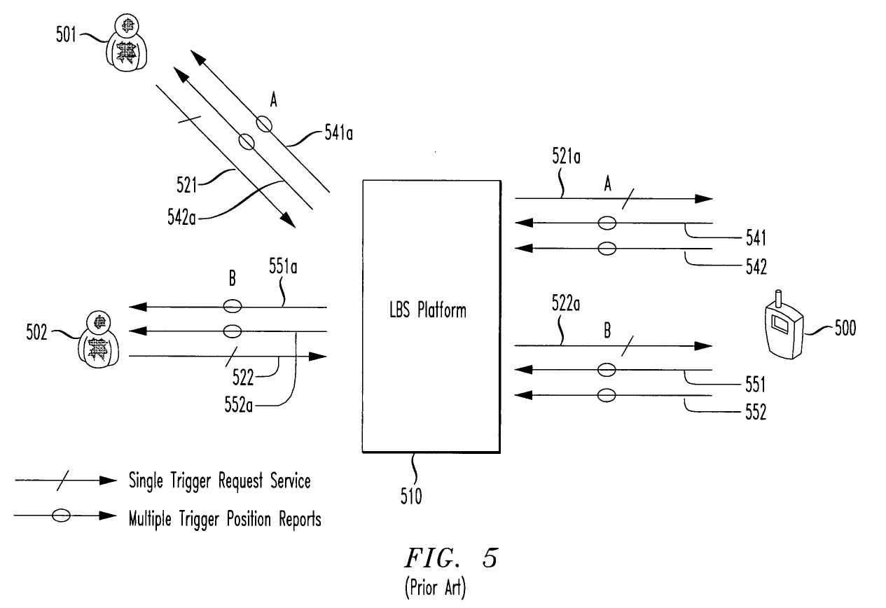

### DETAILED DESCRIPTION OF ILLUSTRATIVE EMBODIMENTS

The present invention provides a technique which evaluates overlapping request intervals, and from them determines a temporal reporting interval that satisfies requirements for all that overlap. The temporal reporting interval represents a temporal trigger used to best support multiple triggers on the same target, without modification or support by the target mobile.

In particular, the disclosed embodiments relate to an example of location requests wherein multiple users, by chance, request location triggered services on the same target mobile during the same time period. To minimize the usage of mobile and network resources, the present invention reduces the number of active triggers on a target mobile subjected to multiple requests (e.g., location requests from multiple tracking applications).

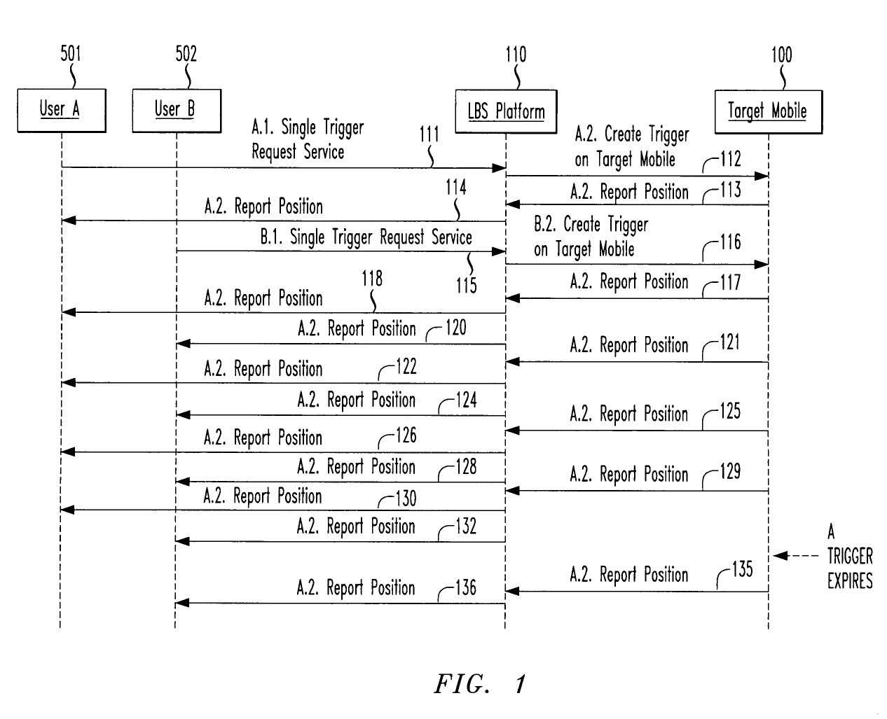

FIG. 1 shows an exemplary message flow including relevant messages using an optimal temporal trigger, in accordance with the principles of the present invention.

In particular, as shown in FIG. 1, a first application or user 501 sends a single trigger request service 111 to the target mobile device 100, via the location services platform 110. The location services platform 110 passes the single trigger request service 111 on to the target mobile in the form of a create trigger on target mobile message 112. The create trigger on target mobile message 112 causes the target mobile device 100 to create a recurring trigger to send back position information on a periodic basis for a given period of time.

In response, the target mobile 100 triggers a report position message 113, which is forwarded by the location services platform 110 to the requesting user 501 in the form of message 114.

Thereafter, while the triggering for position responses by the target mobile 100 is still active such that future location responses are scheduled to be periodically sent by the target mobile 100 to the first user 501, a second user or application 502 also requests a same type information, which in the disclosed embodiments is a position of the target mobile device 100. In this respect, the second user 502 transmits its own single trigger request service message 115 to the location services platform 110, which relays it as a request to create trigger on target mobile message 116.

According to the invention, an optimal temporal trigger best supporting the overlapping requests (e.g., location requests) may then be determined based on information about the requested location triggered service. Exemplary requested location triggered service information that may be used to optimize the temporal response trigger includes target mobile identifier, quality of position, reporting start time, reporting stop time, and reporting interval.

If available, additional information relevant to the determination of an optimal temporal trigger timing may be utilized, e.g., triggered services capabilities of the target mobile device if available, to further optimize the output timing of the optimal temporal trigger. Thus, the invention uses information related to the requested location triggered service in addition to target mobile capabilities to determine and create an optimized temporal trigger. As a result, an optimal temporal trigger is activated on the target mobile to best satisfy multiple location triggered services on the target mobile device requested by multiple users.

When a location trigger request is received from a user, the location server evaluates the requesting parameters and determines if there is an existing location trigger active on that particular target mobile device.

If an existing trigger is not active, the location server activates the trigger on the target device and stores the trigger characteristics for use in future transactions on that particular target mobile.

On the other hand, if there is already an existing active trigger on the target mobile device and yet another location trigger request is received from a user, an optimal temporal trigger is determined that will best satisfy both requesting applications. The optimal temporal trigger is determined on the location server in the exemplary embodiments.

If there is already an active trigger on the target mobile device, the location server inspects, e.g., the quality of position, start and stop time intervals, (and any other available relevant information relating to the active trigger), and determines if the existing active trigger meets the new location trigger request criteria.

When a new trigger request criteria can be met by an existing trigger active on the same target mobile, the location server need not activate a new trigger on the target mobile. Rather, the location server may merely store the new trigger information should it need such information for calculation of an optimal temporal trigger at a later time.

When the target mobile reports its position based on the existing trigger criteria, the location sever reports the position to all active relevant triggers. This is represented in FIG. 1 in subsequent messages 117, 118, 120 wherein an optimal temporal trigger causes a report position message 117 to be output to the location services platform 110, which in turn forwards the necessary number of report position messages 118, 120 to each overlapping requesting user or application 501, 502.

Similar triggering by an optimal temporal trigger established in the target mobile device 100 continues on as long as the period of time requirements of the single trigger request service message 111 from the first user 501 and the single trigger request service message 115 from the second user 502 continue to overlap. Once the required time period for position reporting of one of the users 501, 502 expires, the optimal temporal trigger continues to output report position messages to any unexpired remaining requesting users (e.g., 502 with respect to messages 135 and 136 shown at the bottom of FIG. 1).

Thus, when a new trigger request criteria can not be met by an existing trigger active on the same target mobile, the location server determines if a new temporal trigger can be created which can meet or otherwise best satisfy the trigger criteria of both the active trigger on the target mobile as well as the newly requested trigger.

The optimal temporal trigger may be determined based on any overlap of start time, end time, interval, and/or quality of position.

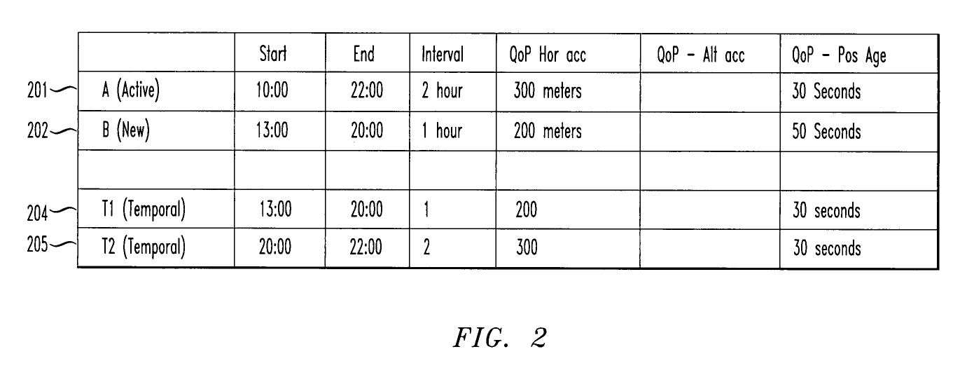

For example, FIG. 2 shows a table representing active trigger A with its trigger characteristics at a time when a request for trigger B is received, in accordance with the principles of the present invention.

In particular, row 201 in the table of FIG. 2 shows exemplary informational content of the single trigger request service 111 from the first user 501 of FIG. 1. In this example, the first user 501 is requesting updates from the target mobile 100 starting at 10:00 and ending at 22:00, at an interval of every 2 hours. Quality of Position (QoP) information is also provided as being within 300 meters, and with a QoP position age of no more than 30 seconds. Thus, if the mobile device 100 does not move (as measured within a QoP of within 300 meters), an updated position should be reported every 2 hours to the first user 501. However, if/when the target mobile device 100 does move outside the 300 meter accuracy for more than 30 seconds, an updated position should be triggered to the first user 501 reporting such movement, with a next scheduled report no later than 2 hours later.

Row 202 in the table of FIG. 2 represents exemplary informational content of the single trigger request service 115 from the second user 502 of FIG. 1. In this example, the second user 502 is requesting updates from the target mobile 100 starting at 13:00 and ending at 20:00, at an interval of no more than 1 hour. Quality of Position (QoP) accuracy is requested at within 200 meters, and with a QoP position age of 50 seconds.

As can be seen, the trigger requested by the second user 502 overlaps with the trigger requested by the first user 501 between 13:00 and 20:00.

From these two trigger request service messages 111, 115, an optimal temporal trigger is determined, as indicated in rows 204 and 205 of FIG. 2. In particular, from 13:00 to 20:00, a report position message 117, 121, 125, 129 is provided to both requesting users 501, 502, at an interval of 1 hour (which satisfies requirements of both requesting users 501, 502), and a QoP accuracy of 200 meters (which again satisfies both requesting users 501, 502), with a QoP position age of no more than 30 seconds (which again satisfies both requesting users 501, 502 for the time period 13:00 to 20:00.

After 20:00, as shown in row 205 of FIG. 2, the trigger request from the second user 502 has expired, and thus the requirements optimal to the remaining user(s) (in this case only the first user 501) take root. In this case, from 20:00 to 22:00, the reporting interval reverts back to at least every 2 hours, with a QoP accuracy of 300, and a QoP position age of no more than 30 seconds.

Thus, as shown in FIG. 2, given the trigger characteristics of requested Triggers A and B, the optimal temporal trigger (comprising components T1 and T2) is calculated to best satisfy the requesting application(s) of triggers A and B. In the given example, once the optimal temporal trigger T1 is calculated, the existing trigger A is cancelled on the target mobile device, and new optimal temporal trigger T1 is activated. Then, later on, once Trigger B goes out of scope of the optimal temporal trigger T1, a new temporal trigger T2 is activated that meets the requirements of trigger A.

The table of FIG. 2 shows an example of the interval aligning due to the start times being on the hour. In cases where the start time does not start on the hour, the location server preferably takes into account the overlap of start time with interval.

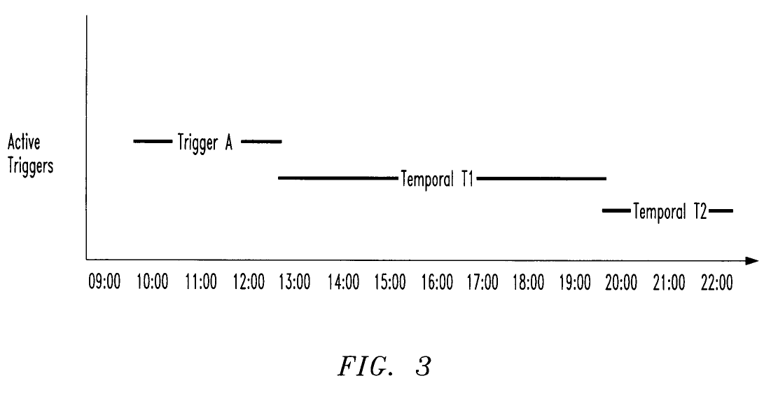

FIG. 3 shows a table representing the exemplary active triggers on a mobile device over time as dictated by the requirements shown in the table of FIG. 2 of Triggers A and B, resulting in an optimal temporal trigger comprising components T1 and T2, in accordance with the principles of the present invention.

Accordingly, a target mobile reports its position to a plurality of requesting applications based on optimal temporal trigger criteria, with the location sever reporting the position of the relevant mobile device in response to all active triggers.

In some cases it may not be feasible for the location server to create a temporal trigger due to the differences in start time and interval. In these cases the location server inspects the capabilities of the target mobile. If the target mobile supports multiple active triggers, the location server activates the new trigger.

When future triggers are requested on the target, all active triggers are inspected to determine if a temporal trigger can be created which meets the requirements of one or more active triggers. The active trigger(s) which can be met by a temporal trigger is(are) then cancelled and replaced by the new temporal trigger.

The present invention has particular applicability for location based server vendors.

While the invention has been described with reference to the exemplary embodiments thereof, those skilled in the art will be able to make various modifications to the described embodiments of the invention without departing from the true spirit and scope of the invention.

1. (canceled)

2. A method of creating an optimum temporal response trigger on a wireless device, comprising:
receiving a plurality of requests for location information;
determining an optimum response level for at least one common parameter of each of said plurality of trigger requests; and
triggering a single response to each of said Plurality of trigger requests based on said optimum response level.

3. The method of creating an optimum temporal response trigger on a wireless device according to claim 2, wherein:
said location information is requested to be sent periodically.

4. The method of creating an optimum temporal response trigger on a wireless device according to claim 2, wherein:
said location information is requested to be sent whenever a location of said wireless device changes outside a given tolerance.

5. The method of creating an optimum temporal response trigger on a wireless device according to claim 2, wherein:
said location information is requested to be sent periodically and whenever a location of said wireless device changes outside a given tolerance.

6. The method of creating an optimum temporal response trigger on a wireless device according to claim 2, wherein said optimum response level comprises at least one of:
target mobile identifier;
quality of position;
reporting start time;
reporting stop time; and
reporting interval.

7. The method of creating an optimum temporal response trigger on a wireless device according to claim 6, wherein said optimum response level further comprises:
triggered services capabilities of said wireless device.

8. The method of creating an optimum temporal response trigger on a wireless device according to claim 2, wherein said optimum response level comprises:
target mobile identifier;
quality of position;
reporting start time;
reporting stop time; and
reporting interval.

9. (canceled)

10. Apparatus for creating an optimum temporal response trigger on a wireless device, comprising:
means for receiving a plurality of requests for location information;
means for determining an optimum response level for at least one common parameter of each of said Plurality of overlapping trigger requests; and
means for triggering a single response to each of said plurality of overlapping trigger requests based on said optimum response level.

11. The apparatus for creating an optimum temporal response trigger on a wireless device according to claim 10, wherein:
said location information is requested to be sent periodically.

12. The apparatus for creating an optimum temporal response trigger on a wireless device according to claim 10, wherein:
said location information is requested to be sent whenever a location of said wireless device changes outside a given tolerance.

13. The apparatus for creating an optimum temporal response trigger on a wireless device according to claim 10, wherein:
said location information is requested to be sent periodically and whenever a location of said wireless device changes outside a given tolerance.

14. The apparatus for creating an optimum temporal response trigger on a wireless device according to claim 10, wherein said optimum response level comprises at least one of:
target mobile identifier;
quality of position;
reporting start time;
reporting stop time; and
reporting interval.

15. The apparatus for creating an optimum temporal response trigger on a wireless device according to claim 14, wherein said optimum response level further comprises:
triggered services capabilities of said wireless device.

16. The apparatus for creating an optimum temporal response trigger on a wireless device according to claim 10, wherein said optimum response level comprises:
target mobile identifier;
quality of position;
reporting start time;
reporting stop time; and
reporting interval.
